(19) United States
(12) Patent Application Publication
(10) Pub. No.: US 2001/0022577 A1
(43) Pub. Date: Sep. 20, 2001

(54) Remote control apparatus including a pointing device

(75) Inventor: Masao Watanabe, Miyagi-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/805,853

(22) Filed: Mar. 14, 2001

(30) Foreign Application Priority Data
Mar. 16, 2000 (JP) 2000-079338

(51) Int. Cl. G09G 5/08

(52) U.S. Cl. 345/161

(57) ABSTRACT

A remote control apparatus comprises a pointing device, keying means provided to the pointing device, key condition detecting means for detecting the ON/OFF conditions of the keying means, ON mode determining means for assuming the keying means to be always in the ON condition when a first condition is satisfied on the basis of the detection result of the key condition detecting means, mode memory means for storing the mode in which the keying means are assumed to be in the ON condition, switch output means not outputting change even when the keying means change to the OFF condition when the keying means are assumed to be in the ON condition, mode canceling means for canceling the mode assumed as the ON condition when a second condition is satisfied and transmitting means for transmitting at least an output from the pointing device and an output from the switch means. Thereby, excellent operation ability is assured and the cursor can be moved without careless canceling of the drag mode during the drag operation.

### BACKGROUND OF THE INVENTION

1. Field of the Invention

The present invention relates to a remote control apparatus including a pointing device that has simplified the drag operation.

2. Description of the Related Art

A pointing device such as a joy-stick that enables the drag of a cursor of a personal computer with remote control operation is integrated with transmitting means to provide a profile wherein the pointing device is structured within a so-called remote control apparatus. In the case where the cursor based on the remote control operation is moved with the joy-stick, the inside push switch (corresponding to the left button of a mouse) is turned ON with depression of the stick and the cursor is moved with the operation (inclination) of the stick while keeping the above condition.

On the occasion of the remote control operation, the pointing device is generally held with a hand and particularly when the drag operation is executed with a joy-stick type, the stick must be inclined while depressing a lever but such operation is difficult in this case and here rises a problem that the drag mode is cancelled because the push switch is turned OFF in the course of the movement of the cursor.

Moreover, in the case of the similar joy-stick of the type that the stick and the push switch are provided independently, both hands are required for operation and thereby the operations are complicated.

### SUMMARY OF THE INVENTION

It is therefore an object of the present invention to provide a pointing device having the remote control function assuring excellent operation capability and movement of cursor without careless cancellation of drag mode during the drag operation.

In view of solving the problem explained above, the present invention comprises a pointing device, keying means provided at the pointing device, key condition detecting means for detecting the ON/OFF conditions of the keying means, ON mode determining means for assuming the keying means to be always in the ON condition when a first condition is satisfied based on the detecting result of the key condition detecting means, mode memory means for storing the mode in which the keying means is assumed to be in the ON condition, switch output means not outputting change even if the keying means changes to the OFF condition when the keying means is assumed to be in the ON condition, mode canceling means for canceling the mode assumed as the ON condition when a second condition is satisfied and transmitting means for transmitting at least an output from the pointing device and an output from the switch means.

Moreover, the pointing device is formed of a joy-stick and thereby the keying means is set to the ON or OFF condition with operation of the stick of the joy-stick.

Moreover, the mode determining means assumes the keying means to be always in the ON condition when the keying means of the pointing device continues the ON condition for a definite time or longer.

In addition, the mode canceling means cancels the mode assumed as the ON condition when the keying means of the pointing device continues the OFF condition for a definite time or longer.

### BRIEF DESCRIPTION OF THE DRAWINGS

FIG. 1 is a block diagram illustrating a schematic structure of the remote control apparatus including the pointing device of the present invention.

FIG. 2 is a flowchart for explaining the operations of the remote control apparatus including the pointing device of the present invention.

FIG. 3 is a flowchart for explaining the operations of the remote control apparatus including the pointing device of the present invention.

### DETAILED DESCRIPTION OF THE PREFERRED EMBODIMENT

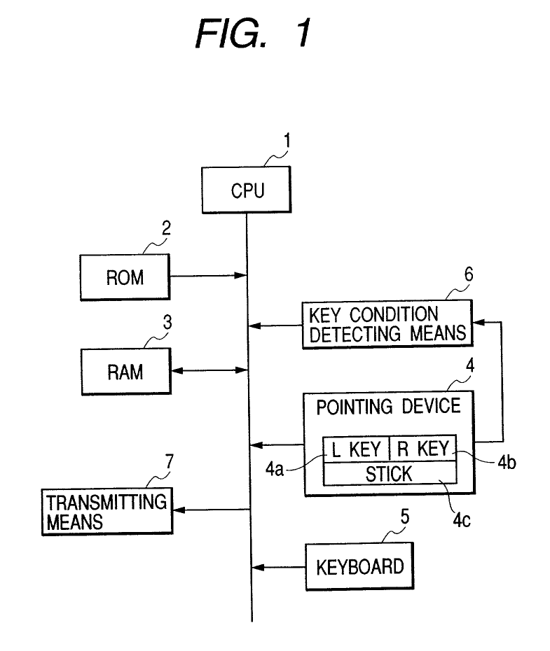

A remote control apparatus including a pointing device (hereinafter referred to only as a remote control apparatus) of the present invention will be explained with reference to FIG. 1 to FIG. 3. FIG. 1 is a block diagram illustrating the schematic structure of the remote control apparatus of the present invention, comprising CPU1, ROM2 storing the control procedures of CPU1, RAM3 for executing the jobs of CPU1, a pointing device 4, a keyboard 5 including a ten-key pad or the like, key-condition detecting means 6 and transmitting means 7, etc.

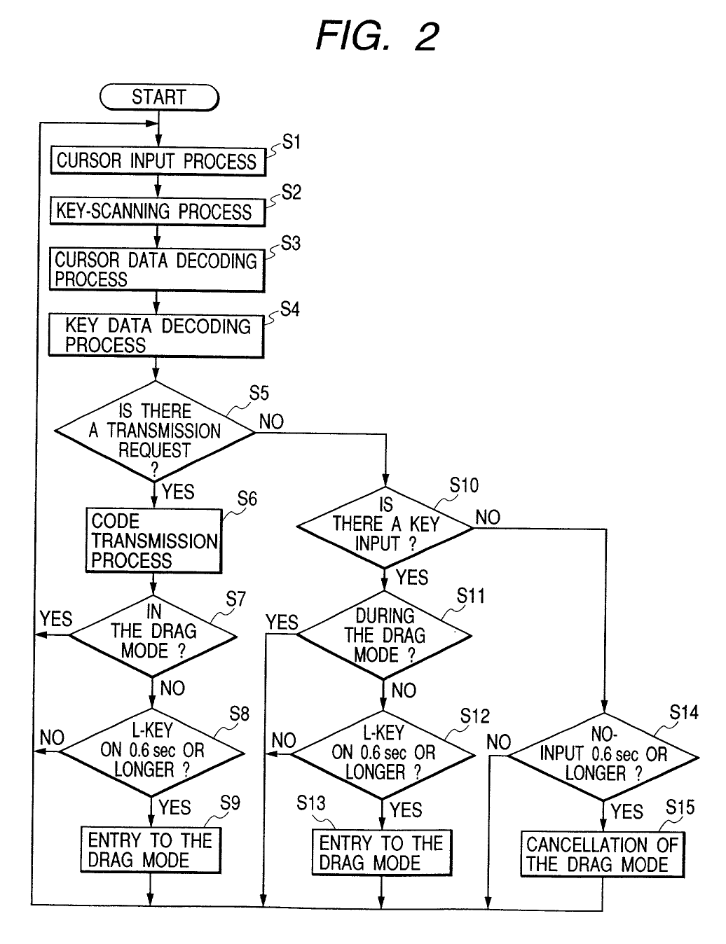

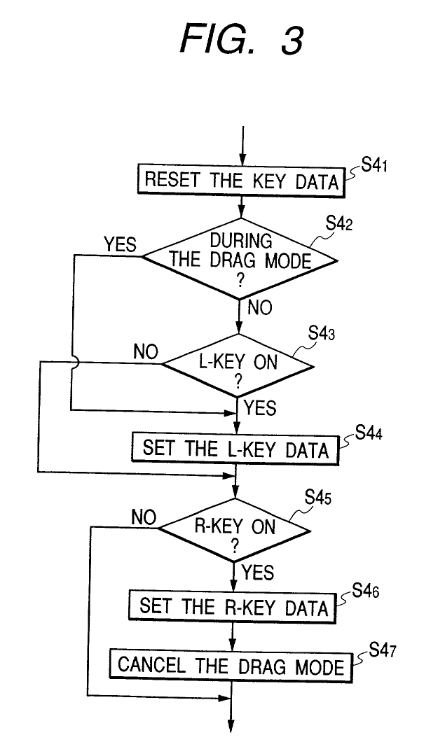

Here, CPU1 has the functions to process the data inputted from the pointing device 4 based on the control system illustrated in FIG. 2 and FIG. 3 and transmit by radio the processed data to personal computers not illustrated.

Moreover, RAM3 stores the programs for setting the remote control apparatus to the drag mode and for canceling the drag mode. When the remote control apparatus is set to the drag mode, it is stored in the RAM3 and a flag is also raised.

As the pointing device 4, a so-called mouse or a joy-stick is used. In this case, the joy-stick is provided with the keying means such as the L key 4a corresponding to the left button of mouse and the R key 4b corresponding to the right button, and the stick 4c as the operating means for moving the cursor. Here, the L key 4a is turned ON by depressing the stick 4c. Moreover, the key condition detecting means 6 is provided to detect the ON or OFF condition of the L key 4a or R key 4b and is also comprised in some cases within the keyboard 5.

Operations of the remote control apparatus of the present invention will be explained with reference to the flowcharts of FIG. 2 and FIG. 3, but the pointing device 4 is replaced with the joy-stick 4.

First, in the steps S1, S2, cursor data (moving velocity and moving direction of the cursor) inputted sequentially from the joy-stick 4 and key scan data inputted from the L key 4a or R key 4b are processed. Thereafter, the cursor data is decoded in the step S3 and the key data is decoded in the step S4.

The practical decoding process in the step S4 is as follows. The key data is reset in the first step S41 as illustrated in FIG. 3 and subsequently the remote control apparatus determines the mode whether it is set to the drag mode or not in the step S42. This determination is made depending on whether the flag indicating the drag mode is raised to the RAM 3 or not. Here, if the drag mode is not yet set, it is detected whether the L key 4a is turned ON or not in the step S43. This detection is executed with the key condition detecting means 6. When it is detected that the L key 4a is turned ON, the data of L key 4a is set in the step S44 and the process thereafter goes to the step S45.

On the other hand, when it is determined that the remote control apparatus is set to the drag mode in the step S42, the process goes to the step S44. If it is not yet detected in the step S43 that the L key 4a is in the OFF condition, the process goes to the step S45.

In the step S45, the ON condition of the R key 4b is detected. This detection is also executed with the key condition detecting means 6. When the R key 4b is ON, the data of R key 4b is set in the step S46 and subsequently the drag mode is cancelled in the step S47 and thereafter the process goes to the step S5. The drag mode is cancelled when the key other than the L key 4a is depressed. On the other hand, when the R key 4b is in the OFF condition in the step S45, the process goes to the step S5.

Next, in the step S5, whether a request for transmission of data to the personal computer side is issued or not is determined. The request is assumed to be issued when there is condition change to ON or OFF of the L key 4a of the joy-stick 4 or movement of the cursor. Then the data is transmitted in the step 6. In this case, when the drag mode is already set, CPU1 operates as the switch output means not to transmit the condition change even if the L key 4a is changed to the OFF condition from the ON condition. Thereby, the personal computer in the receiving side operates as if the L key 4a were depressed.

In the step S7, whether the remote control apparatus is already set to the drag mode or not is determined. When the apparatus is already set to the drag mode, the process returns to the step 1 and if not, the process goes to the step 8. In the step 8, it is determined whether the apparatus should be set to the drag mode or not. In the case of this determination, the depression mode is determined, where CPU1 assumes the L key 4a to be always in the ON condition (depressed with the stick 4c) when the L key 4a continues the first conditions, for example, the ON condition for the definite period (for example, 0.6 sec) or longer and this condition is detected with the key condition detecting means 6. Once the depression mode is determined, since the L key 4a is assumed to continue the ON condition if it is turned OFF, there is no problem even when the L key 4a is erroneously turned OFF with the operation of the stick 4c like the joy-stick 4.

When depression mode is determined, the apparatus is set to the drag mode in the step S9. Once the drag mode is set, it is stored in the RAM3 and the flag indicating this condition is raised to the RAM3. Moreover, when the depression mode is not determined, the process returns to the step S1.

On the other hand, when any transmission request is not issued in the step S5, namely when there is no condition change to ON or OFF of the L key 4a of the joy-stick 4 and where is no movement of the cursor, whether there is a key input or not later is determined in the step S10. When there is a key input, whether the drag mode is set or not is determined in the steps S11 to S13. The processes of step S11 to S13 are identical to that of step S7 to S9 and the same explanation is not repeated here.

When there is no key input in the step S10, whether the second condition continues for the definite time (for example, 0.6 sec) or not is determined. This determination is also made with CPU1 based on the result of detection with the key condition detecting means 6. If there is no key input for the definite period or longer, the drag mode is cancelled in the step S15 and the flag stored in the RAM3 is simultaneously reset. When there is the key input within the definite time, the process returns to the step S1.

As explained above, since the remote control apparatus comprises the keying means provided in the pointing device, the key condition detecting means for detecting the ON/OFF conditions of the keying means, the ON mode determining means assuming the keying means to be always in the ON condition when the first condition is satisfied, the mode memory means for storing the mode wherein the keying means is assumed to be in the ON condition, the switch output means for not outputting the change even if the keying means changes to the OFF condition when the keying means is assumed to be in the ON condition, the mode canceling means for canceling the mode assumed in the ON condition when the second condition is satisfied and the transmitting means for at least transmitting an output from the pointing device and an output from the switch means, excellent operation ability can be implemented and moreover the cursor can be moved during the drag mode without any careless cancellation of the drag mode.

Moreover, since the pointing device is formed of a joy-stick and the keying means is set to the ON or OFF condition with operation of the stick of joy-stick, the drag mode is never cancelled even during the operation of the stick.

In addition, since the mode determining means always assumes the keying means to be in the ON condition when the keying means of the pointing device continues the ON condition a the definite time or longer, the drag mode can easily set only with time setting.

Moreover, since the mode canceling means cancels the mode assumed as the ON mode when the keying means of the pointing device continues the OFF condition for a definite time or longer, the drag mode can be cancelled easily only with time setting.

What is claimed is:

1. A remote control apparatus including a pointing device, comprising a pointing device, keying means provided to the pointing device, key condition detecting means for detecting the ON/OFF conditions of the keying means, ON mode determining means for assuming the keying means to be always in the ON condition when a first condition is satisfied on the basis of the detection result of the key condition detecting means, mode memory means for storing the mode in which the keying means is assumed to be in the ON condition, switch output means not outputting change even when the keying means changes to the OFF condition when the keying means is assumed to be in the ON condition, mode canceling means for canceling the mode assumed as the ON condition when a second condition is satisfied and transmitting means for transmitting at least an output from the pointing device and an output from the switch means.

2. A remote control apparatus including a pointing device according to claim 1, wherein the pointing device is formed of a joy-stick and the keying means is set to the ON or OFF condition with operation of the stick of the joy-stick.

3. A remote control apparatus including a pointing device according to claim 1, wherein the mode determining means assumes the keying means to be always in the ON condition when the keying means of the pointing device continues the ON condition for a definite time or longer.

4. A remote control apparatus including a pointing device according to claim 1, wherein the mode canceling means cancels the mode assumed as the ON condition when the keying means of the pointing device continues the OFF condition for a definite time or longer.
